(19) United States
(12) Patent Application Publication
(10) Pub. No.: US 2019/0255749 A1
(43) Pub. Date: Aug. 22, 2019

(54) INSTRUMENT PANEL FORMING METHOD, INSTRUMENT PANEL, AND INSTRUMENT PANEL FORMING APPARATUS

(71) Applicant: HONDA MOTOR CO., LTD., Tokyo (JP)

(72) Inventors: Taiki Moriizumi, Hagagun, Tochigi (JP); Noboru Hirano, Hagagun, Tochigi (JP); Shigeo Inai, Hagagun, Tochigi (JP); Toshihiro Saimura, Hagagun, Tochigi (JP); Yuuki Kami, Hagagun, Tochigi (JP)

(21) Appl. No.: 16/082,055

(22) PCT Filed: Mar. 1, 2017
(86) PCT No.: PCT/JP2017/008137

§ 371 Date: Sep. 4, 2018

(30) Foreign Application Priority Data
Mar. 30, 2016 (JP) 2016-067769

(51) Int. Cl. B29C 45/16

(52) U.S. Cl. CPC B29C 45/1639; B29K 2023/12

(57) ABSTRACT

An instrument panel forming method is provided with: a first supply step for supplying a base material 103 that will form the base material part and the different material 303 that will form the different material part into the cavity; and a second supply step for opening, with the pressure applied on the different material 303 maintained to be greater than the pressure applied on the base material 103, the frame-shaped core 215 to bring the base material 103 into contact with the different material 303 and cause the different material 303 to protrude into the base material 103 in the central section of the boundary between the base material 103 and the different material 303 in the thickness direction of the base material 103 and the different material 303 where solidification of the base material 103 and the different material 303 is delayed.

### TECHNICAL FIELD

The present invention relates to an instrument panel forming method in which an instrument panel for a vehicle is provided with an air bag device for a passenger's seat, an instrument panel, and an instrument panel forming apparatus.

### BACKGROUND ART

Conventionally, a vehicle is provided with an airbag device for a passenger's seat (hereinafter referred to as an “airbag device”) for an occupant seated in the passenger's seat. The airbag device is provided on a rear side (a side opposite to a cabin side) of the instrument panel. When the air bag device is operated and a bag body inside the airbag device is inflated, a part of the instrument panel is broken by being pushed against the inflating bag body, and the bag body is deployed in the vehicle interior. Therefore, a part of the instrument panel has a fragile part that is liable to be broken when the bag body is deployed. Specifically, the instrument panel has a base material part, and a different material part disposed in a state of being surrounded by the base material part and made of a material different from the base material part, and the different material part has a fragile part (see, for example, Patent Document 1).

Patent Document 1: Japanese Unexamined Patent Application, Publication No. H10-273001

### DISCLOSURE OF THE INVENTION

### Problems to be Solved by the Invention

The instrument panel forming method is not disclosed in the above-mentioned publication, and it is conceivable that, for example, the preformed different material part is arranged in a cavity of the mold and the base material part is formed in the cavity. However, with this method, the number of steps involved in the manufacturing of the instrument panel is large, which makes it difficult to reduce the number of steps.

The present invention is made to solve the above problems, and an object of the present invention is to provide an instrument panel forming method capable of manufacturing an instrument panel with a reduced number of steps, an instrument panel, and an instrument panel forming apparatus.

### Means for Solving the Problems

(1) In an instrument panel forming method for forming an instrument panel (for example, an instrument panel 1 to be described later) having a base material part (for example, a base material part 10 to be described later) made of a base material (for example, a base material 103 to be described later), and a different material part (for example, a different material part 30 to be described later) that is disposed in a state of being surrounded by the base material part and is made of a different material (for example, a different material 303 to be described later) different from the base material, the method includes: a first supply step of closing a frame-shaped core (for example, a frame-shaped core 215 to be described later) at a position of a cavity (for example, a cavity 250 to be described later) that is a boundary (for example, a boundary B to be described later) between the base material part and the different material part of the instrument panel after forming, setting the cavity to a state of being separated into a base material part-forming section (for example, a base material part-forming section 260 to be described later) and a different material part-forming section (for example, a different material part-forming section 270 to be described later), and supplying the base material serving as the base material part and the different material serving as the different material part to the cavity; and a second supply step of opening the frame-shaped core with a pressure applied to the different material kept greater than a pressure applied to the base material, bringing the base material and the different material into contact with each other, and causing the different material to protrude into the base material and to be joined to the base material, in a central part (for example, a portion O including a central part to be described later) of a boundary between the base material and the different material in a thickness direction of the base material and the different material in which solidification of the base material and the different material is delayed.

(2) An instrument panel (for example, an instrument panel 1 to be described later) includes a base material part (for example, a base material part 10 to be described later) made of a base material (for example, a base material 103 to be described later), and a different material part (for example, a different material part 30 to be described later) that is disposed in a state of being surrounded by the base material part and is made of a different material (for example, a different material 303) different from the base material, in which a boundary (for example, a boundary B to be described later) between the base material part and the different material part exists at a position of a trace (for example, a frame-shaped core trace D, E to be described later) of a frame-shaped core formed on the instrument panel and a position of the trace of the frame-shaped core at which a cavity (for example, a cavity 250 to be described later) of a mold for forming the instrument panel is separated into a base material part-forming section (for example, a base material part-forming section 260 to be described later) for forming the base material part and a different material part-forming section (for example, a different material part-forming section 270 to be described later) for forming the different material part, and the boundary protrudes toward the base material part side in a central part (for example, a portion O including a central part to be described later) of the base material part and the different material part in a thickness direction of the base material part and the different material part.

(3) An instrument panel forming apparatus includes a cavity (for example, a cavity 250 to be described later); a frame-shaped core (for example, a frame-shaped core 215 to be described later) movable between a separation position at which the cavity is separated into a base material part-forming section (for example, a base material part-forming section 260 to be described later) and a different material part-forming section (for example, a different material part-forming section 270 to be described later), and an integral position at which the cavity is set to an integral state without being separated into the base material part-forming section and the different material part-forming section; a base material injection part (for example, a base material injection part 211 to be described later) that fills the base material (for example, a base material 103 to be described later) into the base material part-forming section when the frame-shaped core is at the separation position; a different material injection part (for example, a different material injection part 213 to be described later) that fills a different material (for example, a different material part 30 to be described later) into the different material part-forming section when the frame-shaped core is at the separation position; and a pressing part (for example, a different material injection part 213 to be described later) that applies pressure to the different material when the frame-shaped core is at the integral position.

According to the inventions of (1) to (3), it is possible to form the base material part and the different material part in the cavity formed in one mold and to join them together. Therefore, it is possible to omit the step of previously forming the different material part in another mold, to manufacture the instrument panel with a reduced number of steps, to form the instrument panel with high working efficiency.

Further, since the different material part-forming section is formed in the cavity using the frame-shaped core, it is possible to suppress an increase in an amount of the different material constituting the different material part due to the excessive flow of the different material in the cavity. Therefore, it is possible to form the different material part by minimizing the amount of different material serving as the different material part as much as possible.

Further, after the base material part-forming section is filled with the base material and the different material part-forming section is filled with the different material, when the frame-shaped core is moved and the cavity is in a state of not being separated into the base material part-forming section and the different material part-forming section, since a pressure is applied to different materials, the portion of the base material that abuts on the upper mold and the lower mold is liable to generate heat shrinkage to the upper mold and the lower mold, and solidification is faster than the interior. Therefore, the different material to which a greater pressure is applied at the central part in which the solidification is slow presses the base material to which a smaller pressure is applied, and it is possible to cause the different material to enter the inside of the base material to protrude into the base material, in the central part of the boundary between the base material and the different material in which the solidification of the base material and the different material is delayed, and a portion including the central part. Therefore, it is possible to absorb the expansion and shrinkage due to the difference in shrinkage ratio between the base material and the different material at the boundary, and it is possible to suppress deformation caused by pressing of the base material by the different material after the mold opening, which is caused by a difference in shrinkage ratio between the base material and the different material.

### Effects of the Invention

According to the present invention, it is possible to provide an instrument panel forming method capable of manufacturing an instrument panel with a reduced number of steps, an instrument panel, and an instrument panel forming apparatus.

### BRIEF DESCRIPTION OF THE DRAWINGS

FIG. 1 is a perspective view of an essential part illustrating an instrument panel according to an embodiment of the present invention.

FIG. 2 is a schematic view illustrating a boundary between a base material part and a different material part of the instrument panel according to the embodiment of the present invention.

FIG. 3 is a schematic cross-sectional view illustrating a cavity separating step of an instrument panel forming method according to the embodiment of the present invention.

FIG. 4 is an enlarged perspective view of an essential part illustrating a frame-shaped core 215 of an instrument panel forming apparatus according to the embodiment of the present invention.

FIG. 5 is a schematic cross-sectional view illustrating a base material filling step of the instrument panel forming method according to the embodiment of the present invention.

FIG. 6 is a schematic cross-sectional view illustrating a different material filling step of the instrument panel forming method according to the embodiment of the present invention.

FIG. 7 is a schematic cross-sectional view illustrating a frame-shaped core opening step and a different material pressing step of the instrument panel forming method according to the embodiment of the present invention.

FIG. 8 is an enlarged cross-sectional view of an essential part illustrating a state of a base material and a different material in the different material pressing step of the instrument panel forming method according to the embodiment of the present invention.

FIG. 9 is a schematic cross-sectional view illustrating a mold opening step of the instrument panel forming method according to the embodiment of the present invention.

FIG. 10 is a schematic view illustrating a trace C and frame-shaped core traces D and E formed on the instrument panel according to the embodiment of the present invention.

### PREFERRED MODE FOR CARRYING OUT THE INVENTION

Hereinafter, embodiments of the present invention will be described in detail with reference to the drawings.

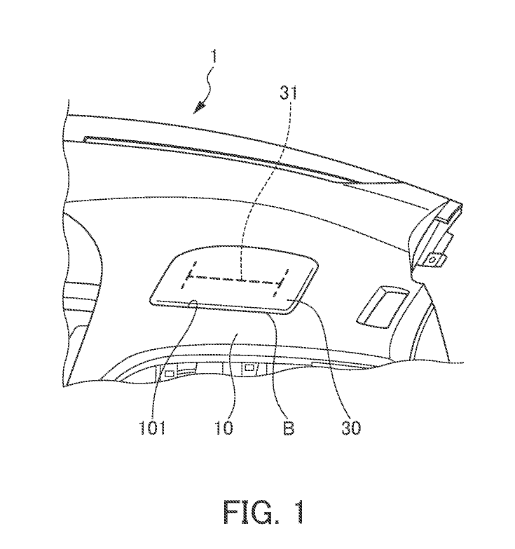

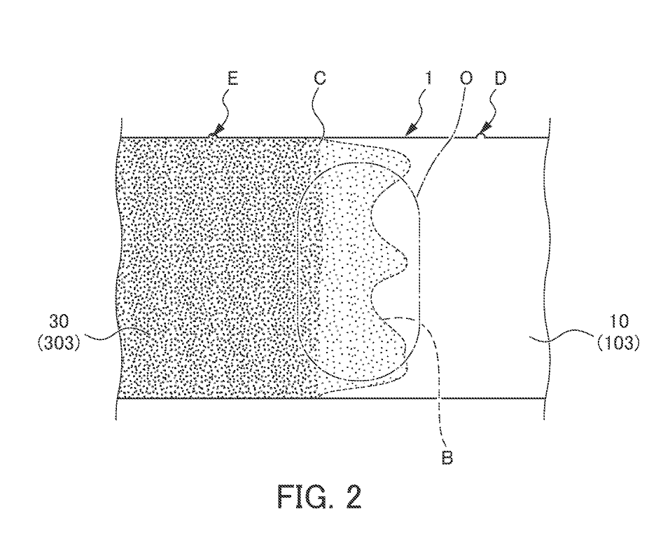

First, an instrument panel 1 will be described. FIG. 1 is a perspective view of an essential part illustrating the instrument panel 1 according to an embodiment of the present invention. FIG. 2 is a schematic view illustrating a boundary B between a base material part 10 and a different material part 30 of the instrument panel 1 according to the embodiment of the present invention.

The instrument panel 1 has the base material part 10, the different material part 30, and a skin (not illustrated). The different material part 30 is made by forming a different material 303 made of an olefinic elastomer (TPO). A storage space (not illustrated) in which an airbag device (not illustrated) for passenger's seat (hereinafter referred to as an “airbag device”) is stored is formed on a rear side of the different material part 30 (on the opposite side to the cabin side). The different material part 30 is arranged to close an opening through which the bag body passes from the storage space to the cabin side when the bag body of the air bag device is deployed. The different material part 30 has a fragile part 31 that is liable to be broken when the bag body of the air bag device is deployed. The fragile part 31 is constituted, for example, by a tear line made by forming a part of the different material part 30 to be thinner than the other part of the different material part 30.

The base material part 10 is positioned over the entire periphery of the different material part 30 to surround the different material part 30 and is joined to the different material part 30. In other words, the different material part 30 is disposed in an opening portion 101 in such a positional relation as to close the opening portion 101 formed in the base material part 10. The base material part 10 is made of polypropylene (PP).

The boundary B between the base material part 10 and the different material part 30 protrudes toward the different material part 30, in a central part of the boundary B between the base material part 10 and the different material part 30 and a portion O including the central part, in a thickness direction (a vertical direction of FIG. 2) of the base material part 10 and the different material part 30. More specifically, as illustrated in FIG. 2, the boundary B between the base material part 10 and the different material part 30 protrudes from the different material part 30 side to the base material part 10 side such that a part of the different material part 30 enters the base material part 10. As a result, the base material part 10 and the different material part 30 are firmly joined.

The boundary B between the base material part 10 and the different material part 30 exists at the positions of frame-shaped core traces D and E indicating a different material part-forming section 270 formed by closing a frame-shaped core 215 as described later. That is, the boundary B is at a position of a trace C indicating a joining position at which the base material 103 filled in a base material part-forming section 260 and the different material 303 filled in the different material part-forming section 270 are joined to each other, and a trace C exists at a position between the frame-shaped core traces D and E. The frame-shaped core traces D and E are formed on the upper surface of the base material part 10 and the upper surface of the different material part 30 in FIG. 2. Although it is not illustrated in FIG. 2, depending on places, a part of the boundary B is located on a side closer to the base material part 10 side (a left side of the frame-shaped core trace D illustrated in FIG. 2) than the frame-shaped core trace D.

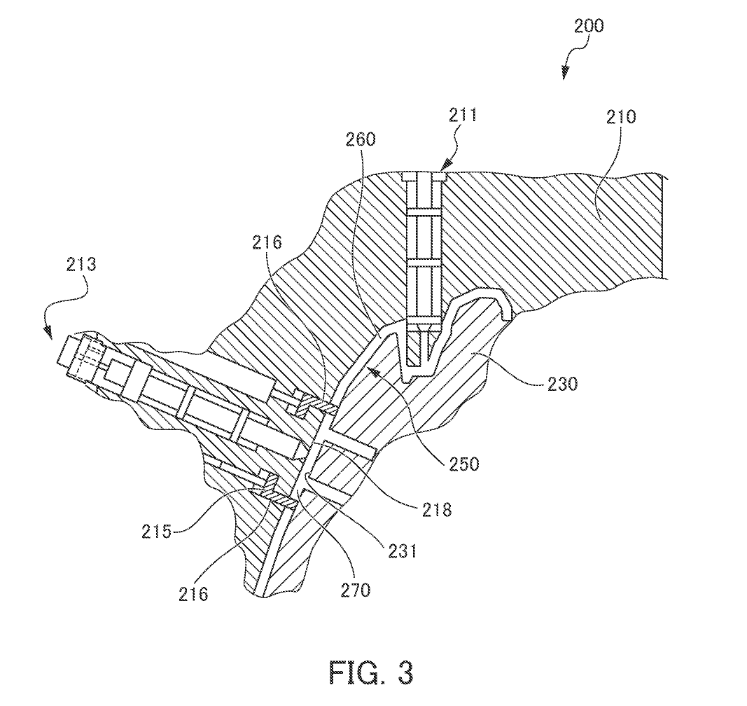

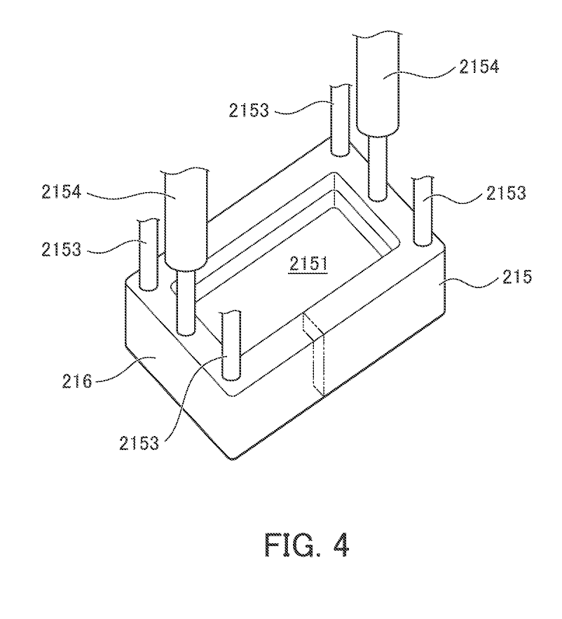

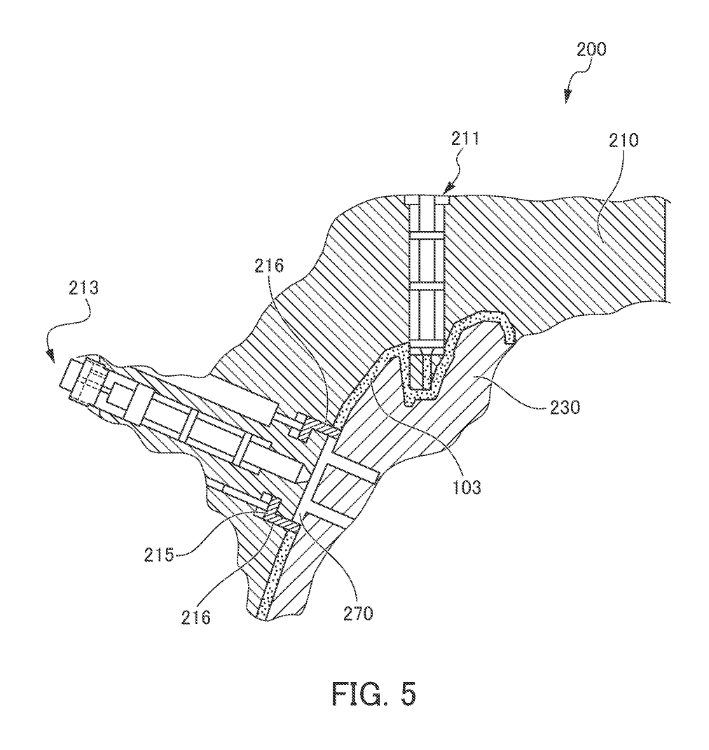

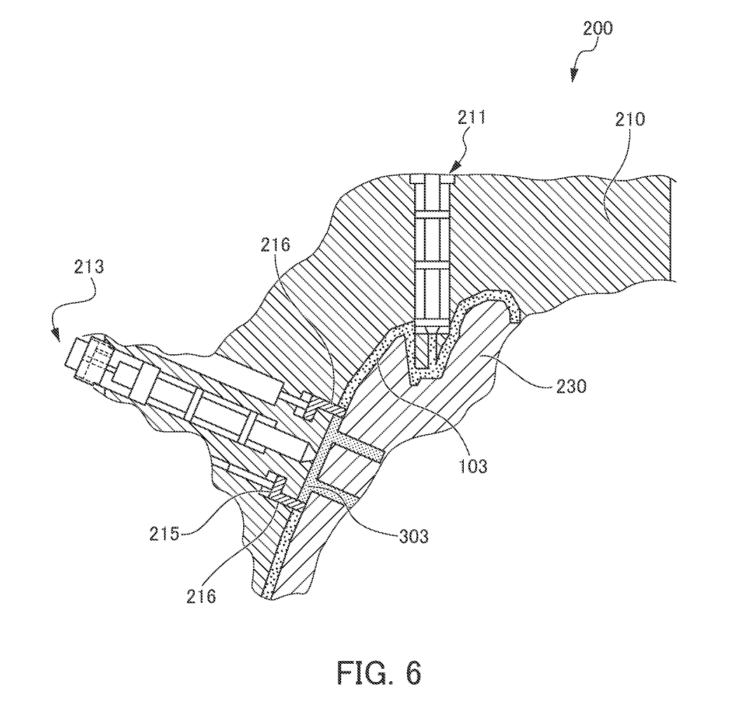

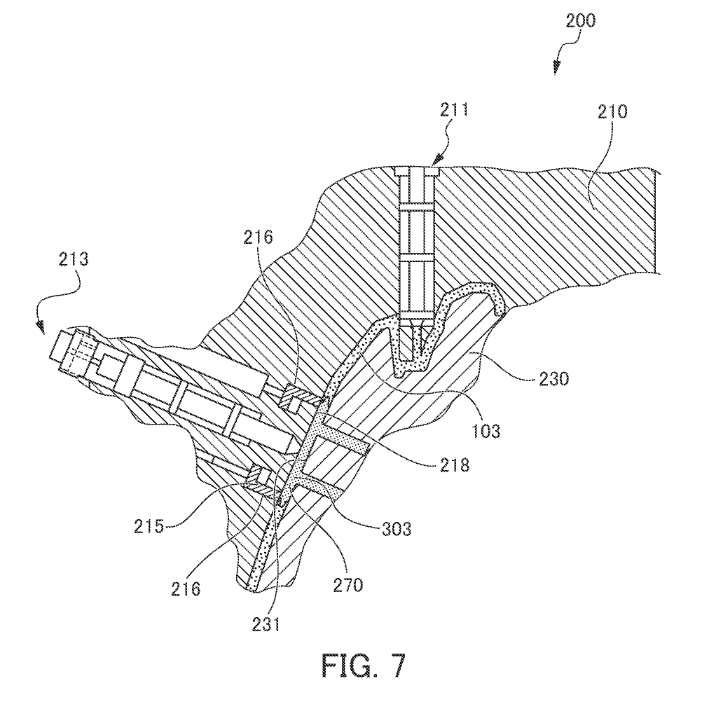

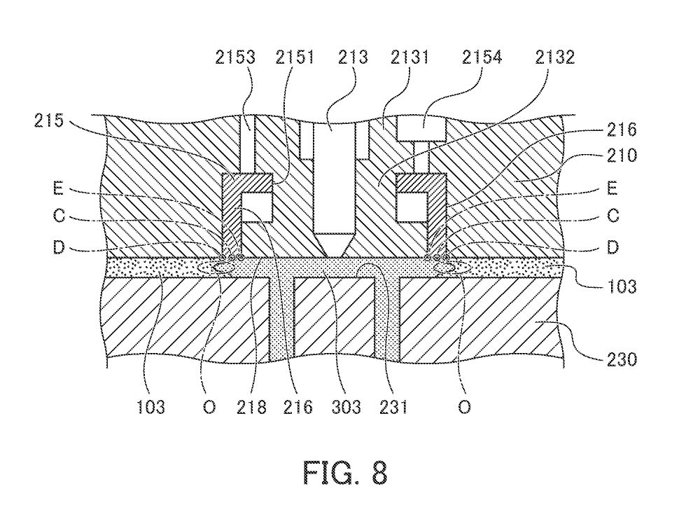

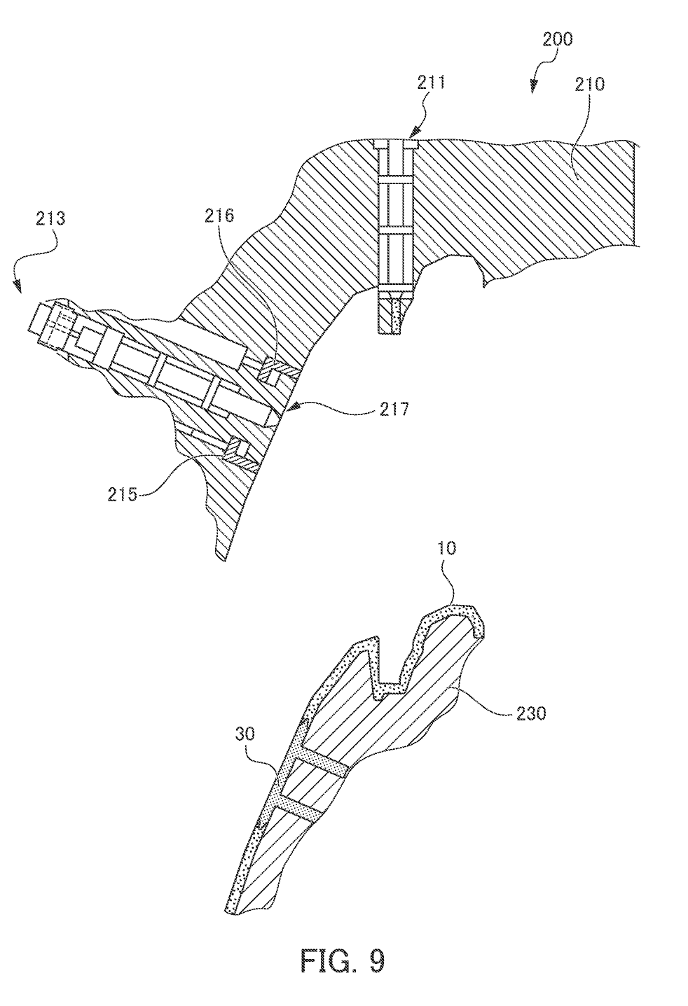

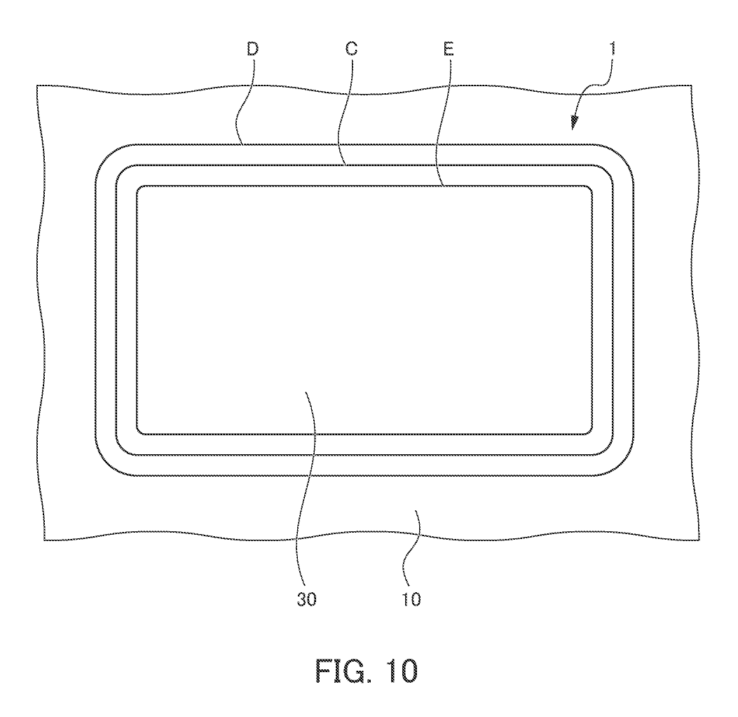

Next, an injection forming mold 200 constituting an instrument panel forming apparatus used in an instrument panel forming method will be described. FIG. 3 is a schematic cross-sectional view illustrating a cavity separating step of the instrument panel forming method according to the embodiment of the present invention. FIG. 4 is an enlarged perspective view of an essential part illustrating the frame-shaped core 215 of an instrument panel forming apparatus according to the embodiment of the present invention. FIG. 5 is a schematic cross-sectional view illustrating a base material filling step of the instrument panel forming method according to the embodiment of the present invention. FIG. 6 is a schematic cross-sectional view illustrating a different material filling step of the instrument panel forming method according to the embodiment of the present invention. FIG. 7 is a schematic cross-sectional view illustrating a frame-shaped core opening step and a different material pressing step of the instrument panel forming method according to the embodiment of the present invention. FIG. 8 is an enlarged cross-sectional view of an essential part illustrating the state of the base material and the different material in the different material pressing step of the instrument panel forming method according to the embodiment of the present invention. FIG. 9 is a schematic cross-sectional view illustrating a mold opening step of the instrument panel forming method according to the embodiment of the present invention. FIG. 10 is a schematic view illustrating a trace C and frame-shaped core traces D and E formed on the instrument panel according to the embodiment of the present invention.

The injection forming mold 200 has an upper mold 210 and a lower mold 230. Clamping is performed by relatively moving the lower mold 230 to be closer to the upper mold 210, and mold-opening is performed by relatively separating the lower mold 230 from the upper mold 210. By performing clamping using the upper mold 210 and the lower mold 230, a cavity 250 in which the base material part 10 and the different material part 30 are formed is formed. The cavity 250 has the base material part-forming section 260 and the different material part-forming section 270.

The upper mold 210 includes a base material injection part 211, a different material injection part 213, and a frame-shaped core 215. A leading end portion of the base material injection part 211 is opened in the base material part-forming section 260 of the cavity 250, and the base material injection part 211 fills the cavity 250 with the base material 103 that is the base material part 10. The leading end portion of the different material injection part 213 is opened at the different material part-forming section 270 of the cavity 250, the different material injection part 213 fills the cavity 250 with the different material 303 that is the different material part 30.

The frame-shaped core 215 is provided near the leading end portion of the different material injection part 213. The frame-shaped core 215 temporarily separates a partial region of the cavity 250 from other regions of the cavity 250. A partial region of the cavity 250 separated by the frame-shaped core 215 constitutes the different material part-forming section 270 in which the different material 303 is filled and the different material part 30 is formed. Other regions of the cavity 250 other than the partial region constitutes the base material part-forming section 260 in which the base material 103 is filled and the base material part 10 is formed. That is, the frame-shaped core 215 separates the base material 103 and the different material 303 from each other so that the different material 303 filled in the separated region and the base material 103 filled in another region other than the different material 303 do not come into contact with each other. In the different material part-forming section 270, a convex part (not illustrated) for forming a tear line in the different material part 30 protrudes toward the inside of the different material part-forming section 270.

The frame-shaped core 215 is configured to be movable with respect to the leading end portion of the different material injection part 213 and the upper mold 210. More specifically, the frame-shaped core 215 has a substantially rectangular frame shape, as illustrated in FIG. 4, rectangular through-hole 2151 is formed in the central part. A cross-section orthogonal to a longitudinal direction of the one side in the portion corresponding to one side of the substantially rectangular frame-shaped core 215 has an L shape as illustrated in FIGS. 3 and 4. As illustrated in FIG. 8, a peripheral part penetration section 2132 of an injection part periphery section 2131 provided to surround the periphery of the leading end portion of the different material injection part 213 passes through the through-hole 2151. An upper part and a lower part of the peripheral part penetration section 2132 have a shape that is enlarged in a substantially flange shape than the peripheral part penetration section 2132. The lower part of the injection part periphery section 2131 has a positional relation facing a different material part-forming section forming surface 231 of the lower mold 230 for forming the different material part-forming section 270 of the cavity 250. A space, which is surrounded by the different material part-forming section forming surface 231, a facing surface 218 of the lower part of the peripheral part penetration section 2132 of the injection part periphery section 2131 facing the different material part-forming section forming surface 231, and a side wall 216 of the frame-shaped core 215 abutting on the lower mold 230, constitutes the different material part-forming section 270 of the cavity 250.

A slide guide 2153 having a columnar shape is provided to extend upward in FIG. 4 at the four corners of the upper surface of the frame-shaped core 215 illustrated in FIG. 4, and since the slide guide 2153 is guided with respect to the upper mold 210, the frame-shaped core 215 is configured to be movable backward and forward with respect to the lower mold 230. Further, a pair of cylinders 2154 are connected to both end portions in the longitudinal direction of the upper surface of the frame-shaped core 215 illustrated in FIG. 4, respectively. When the cylinders 2154 are driven, the frame-shaped core 215 is moved backward and forward with respect to the lower mold 230. When the frame-shaped core 215 moves forward with respect to the lower mold 230 and abuts on the lower mold 230 as illustrated in FIG. 3 or the like, the frame-shaped core 215 is at a separation position at which the cavity 250 is separated into the base material part-forming section 260 and the different material part-forming section 270. When the frame-shaped core 215 moves backward with respect to the lower mold 230 and separates from the lower mold 230 as illustrated in FIG. 7 or the like, the frame-shaped core 215 is located at an integral position at which the cavity 250 is in an integral state without being separated into the base material part-forming section 260 and the different material part-forming section 270. That is, the frame-shaped core 215 can move between the separation position and the integral position.

Next, an instrument panel forming method will be described. The instrument panel forming method has a first supply step and a second supply step, and the first supply step has a cavity separating step, a base material filling step, and a different material filling step. The second supply step has a frame-shaped core opening step, a different material pressing step, and a mold opening step.

In the instrument panel forming method, first, the cavity separating step is performed. In the cavity separating step, first, the lower mold 230 is relatively moved forward relative to the upper mold 210 to clamp the mold, thereby forming the cavity 250 as illustrated in FIG. 3. At this time, the frame-shaped core 215 is at the separation position, and when the leading end portion of the side wall 216 of the frame-shaped core 215 abuts on the lower mold 230, the frame-shaped core 215 is closed and the cavity 250 is separated into the base material part-forming section 260 and the different material part-forming section 270. At the position at which the frame-shaped core 215 is closed, more specifically, the position of the side surface forming the base material part-forming section 260 on the side surface of the side wall 216 of the frame-shaped core 215 is the position of the cavity 250 serving as the boundary B between the base material part 10 and the different material part 30 of the instrument panel 1 after forming.

Next, the base material filling step is performed. In the base material filling step, as illustrated in FIG. 5, the base material 103 is injected from the leading end portion of the base material injection part 211 into the base material part-forming section 260 and filled. Further, the base material 103 is pressed with a first pressure by the pressure for injecting the base material 103 from the leading end portion of the base material injection part 211 to the base material part-forming section 260. Next, the different material filling step is performed. In the different material filling step, as illustrated in FIG. 6, a different material 303 is injected into the different material part-forming section 270 from the leading end portion of the different material injection part 213 and filled. Further, the different material 303 is pressed with a second pressure greater than the first pressure, by the pressure for injecting the different material 303 from the leading end portion of the different material injection part 213 to the different material part-forming section 270. In the different material part-forming section 270, since a convex part (not illustrated) for forming a tear line in the different material part 30 protrudes toward the inside of the different material part-forming section 270, a tear line is formed in the different material part 30 by the convex part.

Next, a frame-shaped core opening step is performed. In the frame-shaped core opening step, while maintaining the state in which the base material 103 is pressed with the first pressure and the different material 303 is pressed with the second pressure greater than the first pressure in the base material filling step, as illustrated in FIG. 7, the frame-shaped core 215 is moved backward with respect to the lower mold 230 to open the frame-shaped core 215 and position the frame-shaped core 215 at the integral position, and it is transferred from the state in which the base material part-forming section 260 and the different material part-forming section 270 are separated to a state in which they are not separated. At the same time, the different material pressing step is performed. In the different material pressing step, while pressing the base material 103 with the first pressure, at the same time, the different material 303 is continuously pressed with a second pressure greater than the first pressure.

As a result, the different material 303 spreads in the cavity 250 along the different material part-forming section forming surface 231 and the facing surface 218 of the lower mold 230 and comes into contact with the base material 103. Further, in the base material 103, heat shrinkage to the upper mold 210 and the lower mold 230 is likely to occur at the portions abutting on the upper mold 210 and the lower mold 230, and solidification is faster than in the interior. Therefore, the different material 303 to which a greater pressure is applied at the central part in which the solidification is slow presses the base material 103 to which a smaller pressure is applied, and the different material 303 enters the inside of the base material 103 to protrude into the inside of the base material 103, in the central part of the boundary B (contact surface) between the base material 103 and the different material 303 in which solidification of the base material 103 and the different material 303 is delayed, and the portion O including the central part. Further, the base material 103 and the different material 303 are cooled and solidified in a state in which the different material 303 is joined to the base material 103.

Next, the mold opening step is performed. In the mold opening step, as illustrated in FIG. 9, the lower mold 230 is moved backward relative to the upper mold 210 to open the mold. Further, the formed article constituted by the base material part 10 and the different material part 30 is extracted from the injection forming mold 200. Further, a resin skin is attached to the upper surface of the formed article so that the upper surface of the formed article is covered with the resin skin, thereby manufacturing the instrument panel 1.

According to the present embodiment, the following effects are obtained.

(1) According to a forming method of an instrument panel 1 having a base material part 10 made of a base material 103, and a different material part 30 that is disposed in a state of being surrounded by the base material part 10 and is made of a different material 303 different from the base material 103, the method includes: a first supply step of closing a frame-shaped core 215 at a position of a cavity 250 that is a boundary B between the base material part 10 and the different material part 30 of the instrument panel 1 after forming, setting the cavity 250 to a state of being separated into a base material part-forming section 260 and a different material part-forming section 270, and supplying the base material 103 serving as the base material part 10 and the different material 303 serving as the different material part 30 to the cavity 250; and a second supply step of opening the frame-shaped core 215 with a pressure applied to the different material 303 kept greater than a pressure applied to the base material 103, bringing the base material 103 and the different material 303 into contact with each other, and causing the different material 303 to protrude into the base material 103 and to be joined to the base material 103, in a portion O including a central part of a boundary B between the base material 103 and the different material 303 in a thickness direction of the base material 103 and the different material 303 in which solidification of the base material 103 and the different material 303 is delayed.

(2) The instrument panel 1 of the embodiment includes a base material part 10 made of a base material 103, and a different material part 30 that is disposed in a state of being surrounded by the base material part 10 and is made of a different material 303 different from the base material 103, in which a boundary B between the base material part 10 and the different material part 30 exists at a position of a trace C formed on the instrument panel 1 and a position of the trace C at which a cavity 250 of an injection forming mold 200 for forming the instrument panel 1 is separated into a base material part-forming section 260 for forming the base material part 10 and a different material part-forming section 270 for forming the different material part 30, and the boundary B protrudes toward the base material part 10 side in a portion O including a central part of the base material part 10 and the different material part 30 in a thickness direction of the base material part 10 and the different material part 30.

(3) An injection forming mold 200 constituting an instrument panel forming apparatus of the present embodiment includes: a cavity 250; a frame-shaped core 215 movable between a separation position at which the cavity 250 is separated into a base material part-forming section 260 and a different material part-forming section 270, and an integral position at which the cavity 250 is set to an integral state without being separated into the base material part-forming section 260 and the different material part-forming section 270; a base material injection part 211 that fills the base material 103 into the base material part-forming section 260 when the frame-shaped core 215 is at the separation position; a different material injection part 213 that fills a different material into the different material part-forming section 270 when the frame-shaped core 215 is at the separation position; and a different material injection part 213 as a pressing part that applies pressure to the different material 303 when the frame-shaped core 215 is at the integral position.

Therefore, it is possible to form the base material part 10 and the different material part 30 in the cavity 250 formed in one injection forming mold 200 and to join them together. Therefore, it is possible to omit the step of previously forming the different material part 30 in another injection forming mold, to manufacture the instrument panel 1 with a reduced number of steps, and to form the instrument panel 1 with high working efficiency.

Further, since the different material part-forming section 270 is formed in the cavity 250 using the frame-shaped core 215, it is possible to suppress an increase in an amount of the different material 303 constituting the different material part 30 due to the excessive flow of the different material 303 in the cavity 250. Therefore, it is possible to form the different material part 30 by minimizing the amount of the different material 303 serving as the different material part 30 as much as possible.

Further, after the base material part-forming section 260 is filled with the base material 103 and the different material part-forming section 270 is filled with the different material 303, when the frame-shaped core 215 is moved so that the cavity 250 is in a state of not being separated into the base material part-forming section 260 and the different material part-forming section 270, since a pressure is applied to the different material 303, the portion of the base material 103 that abuts on the upper mold 210 and the lower mold 230 is liable to generate heat shrinkage to the upper mold 210 and the lower mold 230, and solidification is faster than in the interior. Therefore, the different material 303 to which a greater pressure is applied at the central part in which the solidification is slow presses the base material 103 to which a smaller pressure is applied, and it is possible to cause the different material 303 to enter the inside of the base material 103 to protrude into the inside of the base material 103 in the central part of the boundary B (contact surface) between the base material 103 and the different material 303 in which the solidification of the base material 103 and the different material 303 is delayed and the portion O including the central part. Therefore, it is possible to absorb the expansion and shrinkage due to the difference in shrinkage ratio between the base material 103 and the different material 303 at the boundary B, and it is possible to suppress deformation caused by pressing of the base material 103 by the different material 303 after the mold opening, which is caused by a difference in shrinkage ratio between the base material 103 and the different material 303.

The present invention is not limited to the above-described embodiment, and variations, improvements, and the like within the scope of achieving the object of the present invention are included in the present invention.

### EXPLANATION OF REFERENCE NUMERALS

1 INSTRUMENT PANEL
10 BASE MATERIAL PART
30 DIFFERENT MATERIAL PART
103 BASE MATERIAL
211 BASE MATERIAL INJECTION PART
213 DIFFERENT MATERIAL INJECTION PART (PRESSING PART)
215 FRAME-SHAPED CORE
250 CAVITY
260 BASE MATERIAL PART-FORMING SECTION
270 DIFFERENT MATERIAL FORMING SECTION
303 DIFFERENT MATERIAL
B BOUNDARY
C TRACE
D CORE TRACE
E CORE TRACE
O PORTION INCLUDING CENTRAL PART

1. An instrument panel forming method for forming an instrument panel having a base material part made of a base material, and a different material part that is disposed in a state of being surrounded by the base material part and is made of a different material different from the base material, the method comprising:
a first supply step of closing a frame-shaped core at a position of a cavity that is a boundary between the base material part and the different material part of the instrument panel after forming, setting the cavity to a state of being separated into a base material part-forming section and a different material part-forming section, and supplying the base material serving as the base material part and the different material serving as the different material part to the cavity; and
a second supply step of opening the frame-shaped core with a pressure applied to the different material kept greater than a pressure applied to the base material, bringing the base material and the different material into contact with each other, and causing the different material to protrude into the base material and to be joined to the base material, in a central part of a boundary between the base material and the different material in a thickness direction of the base material and the different material in which solidification of the base material and the different material is delayed.

2. An instrument panel comprising a base material part made of a base material, and a different material part that is disposed in a state of being surrounded by the base material part and is made of a different material different from the base material,
wherein a boundary between the base material part and the different material part exists at a position of a trace of a frame-shaped core formed on the instrument panel at which a cavity of a mold for forming the instrument panel is separated into a base material part-forming section for forming the base material part and a different material part-forming section for forming the different material part, and the boundary protrudes toward the base material part side in a central part of the base material part and the different material part in a thickness direction of the base material part and the different material part.

3. An instrument panel forming apparatus comprising:
a cavity;
a frame-shaped core that is movable between a separation position at which the cavity is separated into a base material part-forming section and a different material part-forming section, and an integral position at which the cavity is set to an integral state without being separated into the base material part-forming section and the different material part-forming section;
a base material injection part that fills the base material into the base material part-forming section when the frame-shaped core is at the separation position;
a different material injection part that fills a different material into the different material part-forming section when the frame-shaped core is at the separation position; and
a pressing part that applies a pressure to the different material when the frame-shaped core is at the integral position.
